(19) United States
(12) Patent Application Publication
(10) Pub. No.: US 2022/0346348 A1
(43) Pub. Date: Nov. 3, 2022

(54) ANIMAL FEED TROUGH

(71) Applicant: Realwood Productions, LLC, Rock Hill, SC (US)

(72) Inventors: Bobby Allen Freeman, Rock Hill, SC (US); Taylor Ashton Freeman, Fort Mill, SC (US)

(73) Assignee: Realwood Productions, LLC, Rock Hill, SC (US)

(21) Appl. No.: 17/863,783

(22) Filed: Jul. 13, 2022

Related U.S. Application Data
(63) Continuation-in-part of application No. 17/063,755, filed on Oct. 6, 2020, now Pat. No. 11,412,706.

(51) Int. Cl. A01K 5/01

(52) U.S. Cl. CPC A01K 5/01

(57) ABSTRACT

An animal feed trough is described herein; the animal feed trough mimicking a tree or fallen log. The animal feed trough including a base, a body for storing grain, and an opening for adding grain. The animal feed trough may be mounted to a tree or pole. The base may have a plurality of feed dishes to receive a grain via gravity flow from the body of the feed trough. The trough may have a feed tube to receive grain via gravity flow from the body of the feed trough. The body may have a hinged lid, or lids, to allow animals to feed directly from the body of the trough.

### TECHNICAL FIELD AND BACKGROUND OF THE INVENTION

This invention relates to an animal feed trough, in particular, a feed trough intended to dispense corn or some other grain to feral animals such as deer, elk and the like. Animals are fed in this way to bring them into an area where they can be hunted. For example, hunters will set out a feeder to attract deer into a hunting area during winter or to have a deer population present during the hunting season. In many cases this practice is also carried out as part of a means of thinning a deer population down to a level that is manageable within the context of the geographical location and size of the area where the deer population is present. Over population of deer results in an increase in disease, crowding of deer into residential areas and onto roads, streets and freeways where collisions with vehicles have become commonplace.

Some animal feed troughs are wind or battery powered, and have mechanisms that disperse grain onto the ground around the feeder. Other feeders are gravity fed, and rely on the grain to fall into an access opening where it can be eaten by an animal. Known prior art gravity feeders have narrow, tube-like openings that are prone to clogging and jamming, thus preventing proper and adequate distribution of grain to the animals as intended.

Prior art animal feed troughs tend to be fabricated of sheet metal and are either painted a solid color or left as bare metal. These designs present an appearance that is unnatural and may discourage the animals from approaching the feeder. In addition, many such feed troughs are bulky and therefore difficult and expensive to ship.

### BRIEF SUMMARY

It is therefore an object of the present invention to provide an improved animal feed trough wherein grain is fed by gravity into an area where the animal can access and consume the grain.

It is another object of the invention to provide an improved animal feed trough that feeds the grain into wide feed dishes which permits several animals to feed at the same time.

It is another object of the invention to provide an improved animal feed trough that presents a natural, non-threatening appearance to animals that will encourage them to approach the feed trough.

It is another object of the invention to provide an improved animal feed trough that is compact, collapsible into an easily shippable shape and size, and yet has a large grain capacity.

In one aspect an animal feed trough is disclosed comprising a base, a body, a cylindrical opening, and a round lid configured to close the cylindrical opening. The base of the animal feed trough has a triangular configuration defined by a central ridge extending along the length of the base and tapering downward and outward from the central ridge to define a plurality of feed dishes along the length of the base. The body of the animal feed trough is defined by a hollow semi-cylinder and opposing spaced-apart end caps defining an interior for storing a grain supply. The body has an open bottom with feed slots for gravity flow of grain from the body onto the base and into the plurality of feed dishes.

In some embodiments, the round lid is configured to snap into the cylindrical opening. Additionally, or alternatively, the round lid may be configured to screw into the cylindrical opening.

In some embodiments, the external surface of the body comprises a wood bark configuration. In some embodiments, the animal feed trough further comprises a body cover attached to an outer surface of the hollow semi-cylinder of the body. In some embodiments, the body cover comprises dried wood bark.

In some embodiments, the body and the base comprise a thermoplastic. In some embodiments, the body and the base comprise polyurethane.

In another aspect, a mounted animal feed trough is disclosed comprising a body defined by a tapered hollow semi-cylinder, a first end cap having a first diameter, a second end cap having a second diameter, and a tapered triangular back-side, forming an interior for storing a grain supply. The second diameter is less than the first diameter. The first end cap includes a cylindrical opening for introducing grain into the interior of the body. The second end cap includes a hole for releasing grain from the interior of the body. The mounted animal feed trough also includes a round lid to close the cylindrical opening of the first end cap.

In some embodiments, the round lid is configured to snap into the cylindrical opening. Additionally, or alternatively, the round lid may be configured to screw into the cylindrical opening.

In some embodiments, the external surface of the body comprises a wood bark configuration. In some embodiments, the animal feed trough further comprises a body cover attached to an outer surface of the hollow semi-cylinder of the body. In some embodiments, the body cover comprises dried wood bark.

In some embodiments, the body comprises a thermoplastic. In some embodiments, the body comprises polyurethane.

In another aspect, a top-feed animal feed trough is disclosed comprising a base, a body, and one or more hinged lids. The base has a triangular configuration defined by a central ridge along a length of the base tapering downward and outward from the central ridge. The body is defined by a hollow semi-cylinder and opposing spaced-apart end caps defining an interior for storing a grain supply. The body is configured to be mounted onto and supported by the base. The one or more hinged lids are fixed to the top of the body.

In some embodiments, the external surface of the body and the external surface of the one or more hinged lids comprise a wood bark configuration. In some embodiments, the animal feed trough further comprises a body cover, attached to the outer surface of the hollow semi-cylinder of the body, and one or more hinged lid covers attached to the outer surface of the one or more hinged lids. In some embodiments, the body cover and the one or more hinged lid covers comprise dried wood bark.

In some embodiments, the body, the base, and the one or more hinged lids comprise a thermoplastic. In some embodiments, the body, the base, and the one or more hinged lids comprise polyurethane.

### BRIEF DESCRIPTION OF THE DRAWINGS

The drawings described herein are for illustrative purposes for selected embodiments and not all possible implementations, and are not intended to limit the scope of the present disclosure.

FIG. 1 is a perspective view of an animal feed trough according to a preferred embodiment of the invention with outer covering parts partially broken away for clarity.

FIG. 2 is a perspective view of the animal feed trough of FIG. 1 with the outer covering parts removed.

FIG. 3 is a perspective view of the animal feed trough of FIG. 1 with the outer cover removed and the cover exploded away from the body of the trough for clarity.

FIG. 4 is an enlarged, fragmentary close-up of the base and feed stop portion of the feed dish.

FIG. 5 is an enlarged, fragmentary close-up showing construction details of the body and endcap arrangement that maintains lid alignment.

FIG. 6 is a fragmentary close-up of the body and lid overlap.

FIG. 7 is an overall exploded perspective view of the animal feed trough.

FIG. 8 is a side elevation cross-section and an enlarged detail of a snap-fit detail of the lid attachment.

FIG. 9 is a side elevation cross-section and enlarged details showing retention of the side wall panel and body cover in the base, and formation of the feed stop portion of the feed dish.

FIG. 10 is an overall perspective view of the animal feed trough prior to assembly and in a configuration suitable for storage, packaging and shipment.

FIG. 11 is a perspective view of an animal feed trough according to a preferred embodiment of the invention.

FIG. 12 is a perspective view of an animal feed trough according to a preferred embodiment of the invention.

FIG. 13 is a perspective view of a mounted animal feed trough according to a preferred embodiment of the invention.

FIG. 14 is a side view of a mounted animal feed trough according to a preferred embodiment of the invention.

FIG. 15 is a perspective view of a top-feed animal feed trough according to a preferred embodiment of the invention.

### DETAILED DESCRIPTION OF EMBODIMENTS OF THE INVENTION

Referring now to the drawings, one preferred embodiment of the animal feed trough (“feed trough” or “trough”) is shown at broad reference numeral 10, and includes a base 12 and body 14 including curved body covers 14A, 14B positioned on the base 12. The base 12 has a generally triangular configuration. The body covers 14A, 14B are enclosed on opposite ends by annular body end covers 16, 18 and a top opening 20 is enclosed by a lid cover 22 having lid end covers 24, 26. The body end covers 16, 18 include notches 16A, 18A that align with notches 24A, 26A in the lid end covers 24, 26. In accordance with one preferred embodiment of the invention the opening 20 extends the length of the body 14 and defines an arc of 50 degrees relative to the circular cross-sectional shape of the body 14.

The body covers 14A, 14B and lid cover 22 in accordance with one embodiment are natural bark. The feed trough 10 therefore presents a natural outward appearance of a fallen log—something a forest animal such as a deer would be familiar with and would likely find non-threatening.

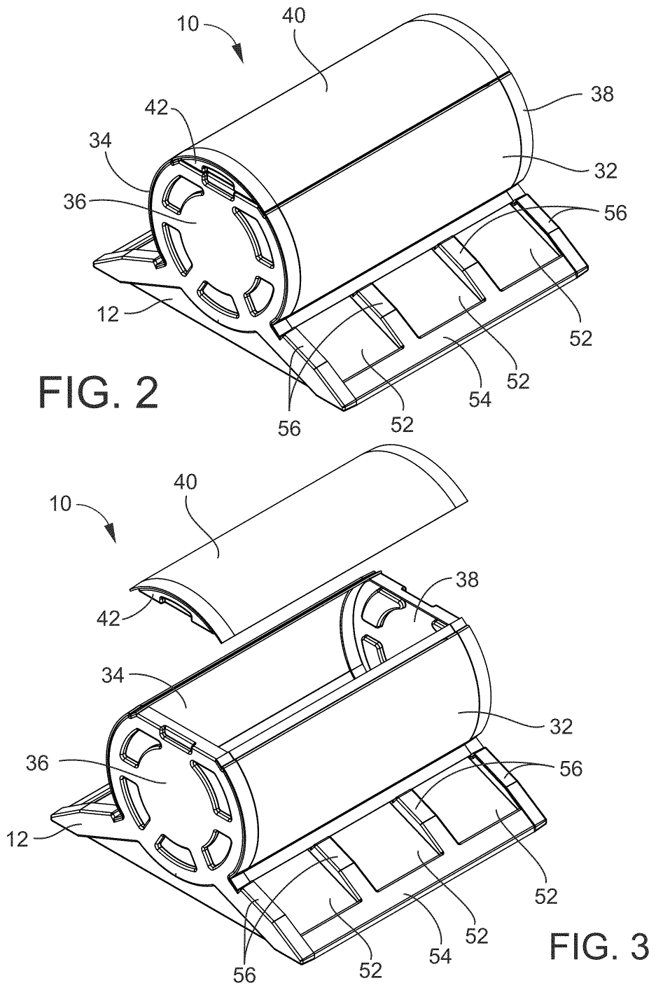

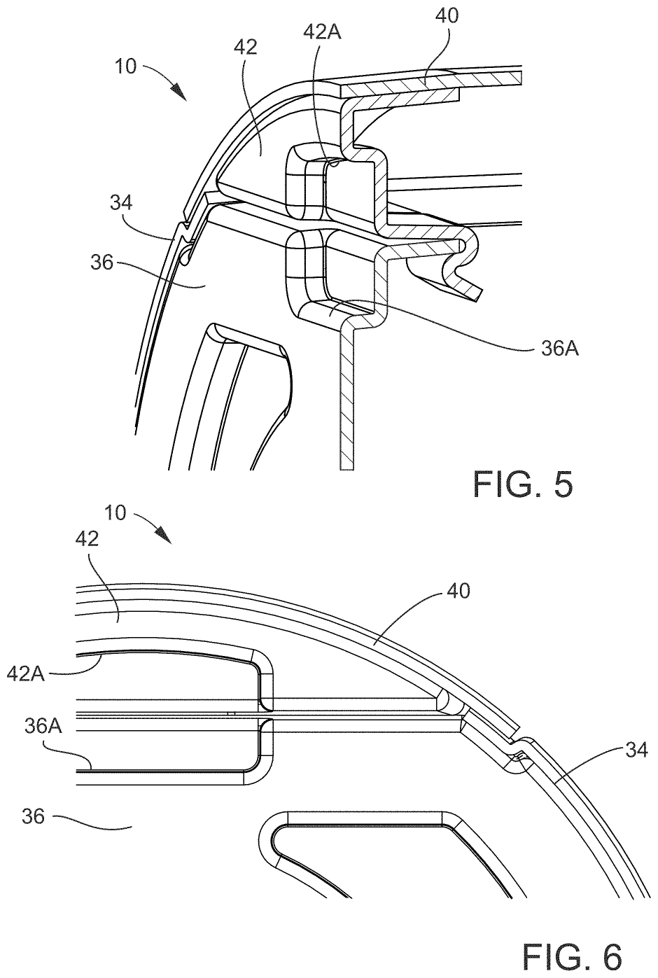

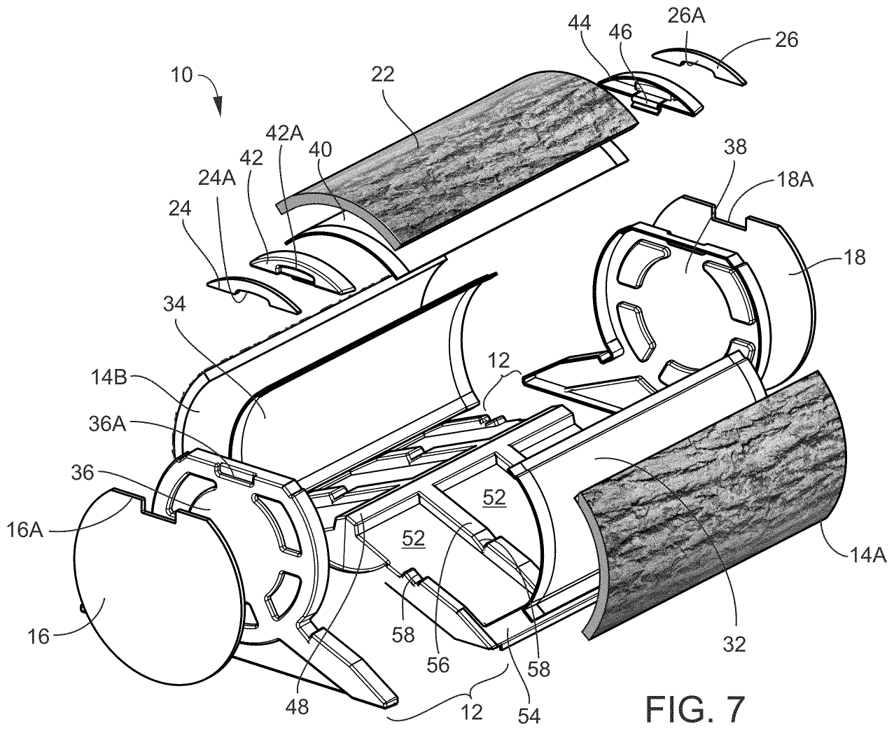

Referring now to FIGS. 2 and 3, the principal structural elements of the feed trough 10 are illustrated and explained. The body covers 14A, 14B are mounted on a pair of side panels 32, 34 that are bolted or riveted to the base 12, as shown. End caps 36 and 38 are likewise preferably bolted or riveted to the side panels 32, 34 to form the interior capacity of the trough 10. The lid cover 22 is mounted onto and supported by a lid panel 40. Lid end caps 42, 44 are positioned in the ends of and support the end caps 36, 38. The lid end caps 42, 44 include notches 42A, 44A that align with notches 36A, 38A in the lid end covers 36, 38. The aligned notches 16A, 18A and notches 24A, 26A in the lid end covers 24, 26, and the aligned notches 42A, 44A and notches 36A, 38A in the lid end caps 36, 38 also align with each other, as shown in FIGS. 5 and 7, and provide hand holds for the user so that the trough 10 can be manually carried as necessary. As an option, the notches 42A, 44A can be opened through to the interior of the trough 10, in which case they will provide a more secure hand hold and provide air exchange between air in the trough 10 and the surrounding ambient air. In some embodiments, the animal feed trough described herein may be configured with a motor and a timer to open/close or dispense feed at a predetermined time. In some embodiments, the timer may be battery-powered.

While a wide variety of materials are suitable, according to one preferred embodiment of the animal feed trough 10, the base 12 and body end caps 36, 38 are UV-protected thermoformed ABS plastic. The side panels 32, 34, lid panel 40 and lid end caps 42, 44 are also thermoformed ABS plastic. In an additional preferred embodiment, the animal feed trough 10, the base 12, and body end caps 36 and 38 are polyurethane. An example polyurethane is ROTOTHANE 4570, a two-component structural urethane, however any suitable polyurethane may be used to form the animal feed trough 10 described herein. In some embodiments, the animal feed trough 10, the base 12, and body end caps 36 and 38 are formed via rotocasting or centrifugal casting. In some embodiments, the animal feed trough 10 and body end caps 36 and 38 are formed together via rotocasting. In some embodiments, the body end covers 16, 18 may be exterior grade plywood. As noted above, covers 14A, 14B and 22 are preferably natural bark. Preferably, the bark is subjected to a kilning process that stabilizes the bark and sets the bark in the correct curvature to match the curvature of the side panels 32, 34 and lid panel 40. The bark covers 14A, 14B and 22 are preferably not permanently mounted to the side panels 32, 34 and lid panel 40, and can be removed if desired and replaced with different bark or with some other surface treatment. The bark covers 14A, 14B and 22 may be attached by a weak adhesive, or mechanically attached by clips, latches, pins or other similar attachment devices. Artificial covers 14A, 14B and 22 may be formed to resemble bark, and may be thermoformed ABS plastic. In some embodiments, the animal feed trough 10, body end caps 36 and 38 end covers 16 and 18, covers 14A-14B and 22. In some embodiments, the animal feed trough described herein may be configured with a motor and a timer to open/close or dispense feed at a predetermined time. In some embodiments, the timer may be battery-powered.

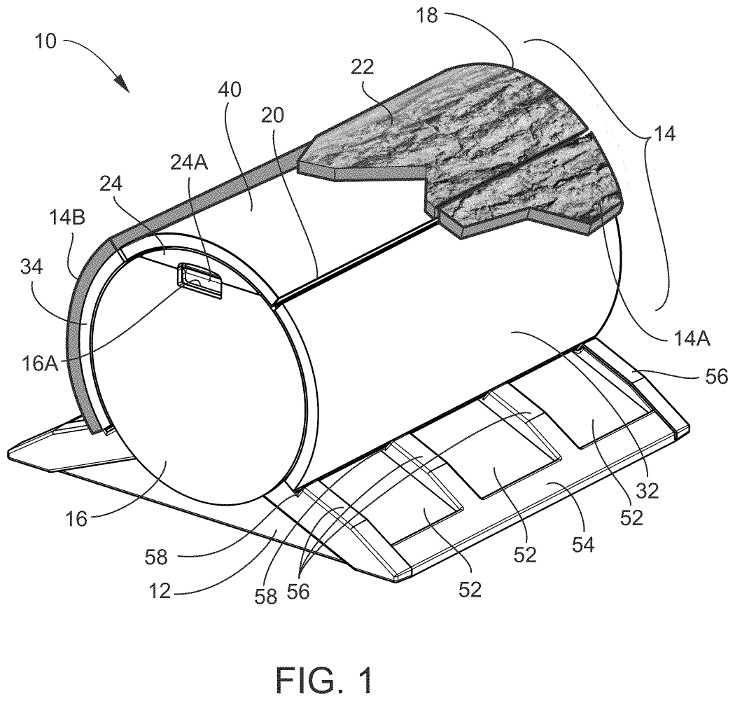

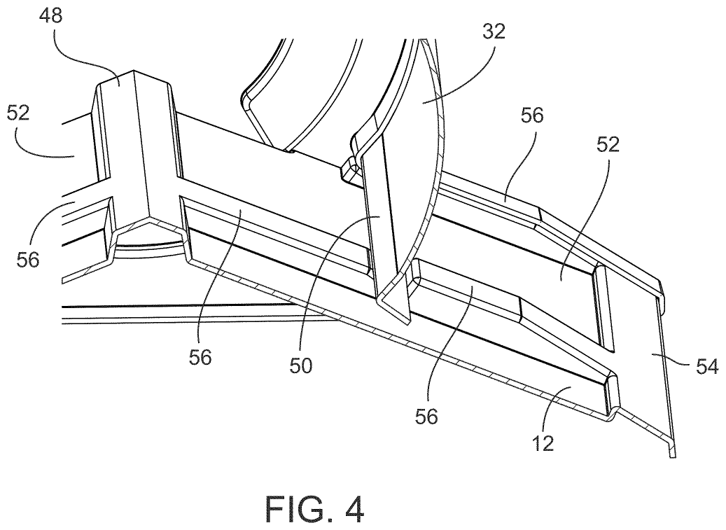

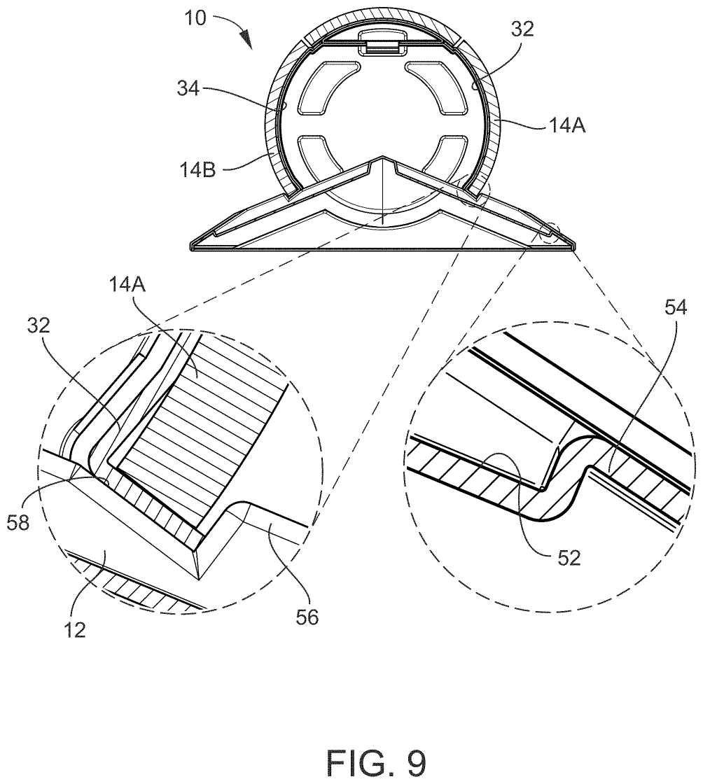

As best shown in FIGS. 1, 2, 3, 7 and 9, the base 12 has a generally triangular shape that promotes gravitation flow of the grain. The side panels 32, 34 are mounted above a raised central ridge 48 that extends along the length of the base 12 and form feed slots 50 through which gravity-fed grain flows from the interior of the body 14. The base 12 has a series of downstream feed dishes 52 that capture and accumulate the grain that falls by gravity through the feed slots 50. As best shown in FIG. 4, molded in feed stops 54 will retard most of the grain from continuing down the feed dishes 52 onto the surrounding ground. The feed dishes 52 are wide and flat and therefore minimize choking or jamming of the grain as it feeds out of the trough 10, as is the case with many other gravity feeders that attempt to transport grain from a large bin through narrow tubes. The feed dishes 52 extend laterally along the length of the trough 10, promoting even flow of grain along the length of the trough 10 and permitting several animals to feed at the same time. Placement of the feed dishes 52 on both sides of the trough 10 further promotes even flow of grain along the length of the trough 10 and permits several animals to feed at the same time on opposite sides of the feeder 10. The feed dishes 52 are defined by raised ribs 56 which extend downwardly from the central ridge 48. As best shown in FIG. 7, the ribs 56 include notches 58 into which the side wall panels 32 and 34 are positioned. While the angle of declination of the feed dishes 52 may vary, in one preferred embodiment the angle of declination of the feed dishes 52 is 25 degrees, but may optionally be between 15 and 35 degrees. In some embodiments the base 12 further includes a flow adjuster to modulate the flow of grain into the feed dishes 52. In some embodiments, the flow adjuster is a mesh lining covering the opening. Additionally, or alternatively, the flow adjuster is a lip affixed to the inside edge of the side wall panels 32 and 34 configured to slow the flow of grain into the feed dishes 52.

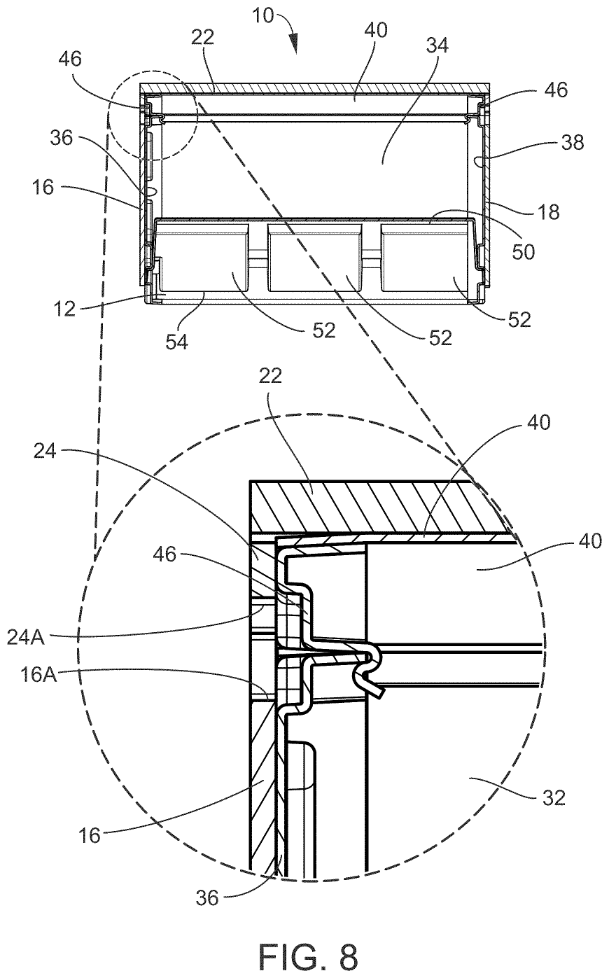

As is shown in FIG. 6, body end caps 36, 38 (36 shown) and lid panel 40 overlap in order to provide resistance to entry of moisture from the surrounding environment into the interior of the trough 10. The lid panel 40 can be releasably attached to the pair of side panels 32, 34 by latches of numerous types, by a snap-fit latch or slide fit configuration between the lid panel 40 and the pair of side panels 32, 34. By way of example, FIG. 8 shows a snap-fit latch 46 mounted on lid end cap 44 that snaps over the top edge of the end cap 38 with a comparable structure on lid end cap 42.

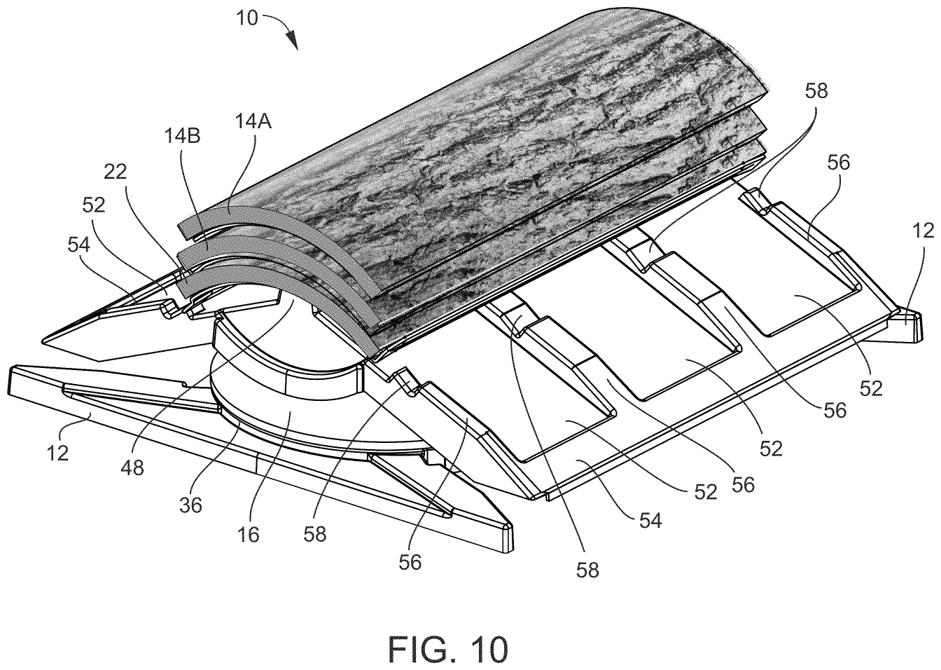

FIG. 10 shows the components of the trough 10 in a nested position prior to assembly and suitable for shipment and storage. By nesting the components in the manner shown, the space that would otherwise exist in the assembled trough 10 is reduced by approximately 50 percent.

While size and capacity can substantially vary, in one preferred embodiment the feeder 10 has a length of 36 in. (91.4 cm); a height of 22.25 in. (56.5 cm); a width of 36 in. (91.4 cm), with a body 12 diameter of 22 in. (55.9 cm). Grain capacity may be approximately 250 lbs. (113 kg.) depending on the type of grain, moisture content and similar factors. In another preferred embodiment, the feeder 10 has a length of 34 in. (86.4 cm); a height of 22.25 in. (56.5 cm); a width of 36 in. (91.4 cm), with a body 12 diameter of 22 in. (55.9 cm). Grain capacity may be approximately 200 lbs. (90.7 kg.) depending on the type of grain, moisture content and similar factors.

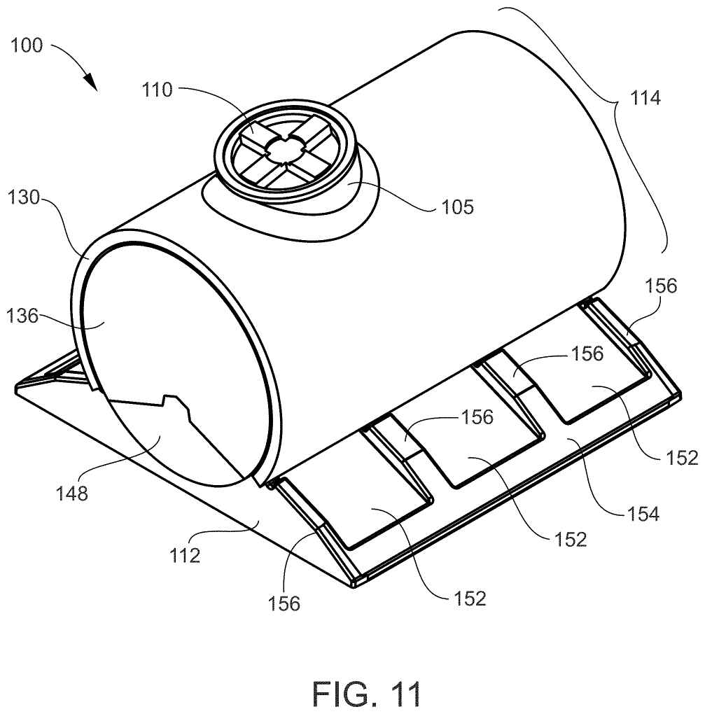

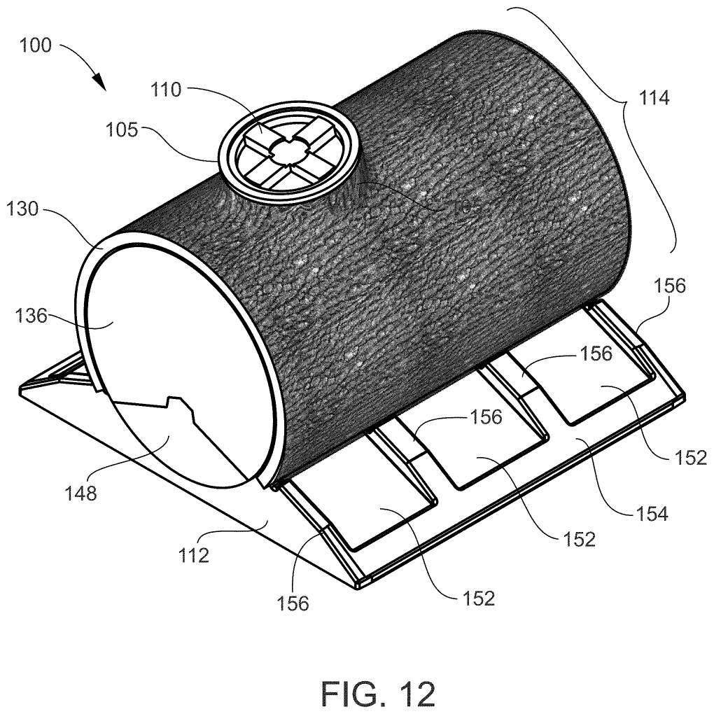

An additional embodiment is illustrated in FIGS. 11 and 12. The animal feed trough 100 includes a body 114, a base 112, a cylindrical opening 105, and a lid 110.

The body 114 is defined by a hollow semi-cylindrical core 130 flanked by two end caps 136 forming an interior for storing grain. The hollow semi-cylindrical core 130 of the body 114 includes a cylindrical opening 105 for adding grain to the interior of the body 114. The cylindrical opening may further include a lid 110 to keep the grain protected from moisture. In some embodiments, the lid 110 screws into the cylindrical opening 105. Additionally, the lid 110 may snap into the cylindrical opening 105. In some embodiments, the lid 110 is a Gamma Seal Lid®.

The hollow semi-cylindrical core 130 may be comprised of a thermoplastic such as ABS or polyurethane. In some embodiments, the hollow semi-cylindrical core 130 is formed via rotocasting. In some embodiments, the mold used during rotocasting comprises a natural wood bark pattern resulting in a wood bark configuration on the external surface of the body 114.

In some embodiments, the two end caps 136 may be comprised of exterior grade plywood. Alternatively, the two end caps 136 may be comprised of a thermoplastic such as ABS or polyurethane. In some embodiments, the hollow semi-cylindrical core 130 and the two end caps 136 are rotocasted from the same mold. Alternatively, the hollow semi-cylindrical core 130 is rotocasted in a separate mold from the two end caps 136, and assembled after removal from the mold. In some embodiments, the two end caps 136, may be bolted or riveted to the hollow semi-cylindrical core 130. The two end caps 136 are configured to mount the raised central ridge 148 of the base 112.

In some embodiments, the body 114 may further include a body cover. The body cover may be natural wood bark. Preferably, the bark is subjected to a kilning process that stabilizes the bark and sets the bark in the correct curvature to match the curvature of the hollow semi-cylindrical core 130. The body cover may also be a polymeric material configured to resemble wood bark. Suitable polymeric materials include: ABS, polyurethane, as well as other thermoplastics. In some embodiments, where the animal feed trough 100 comprises a body cover, the body cover may be attached by a weak adhesive, or mechanically attached by clips, latches, pins or other similar attachment devices. The body cover may be non-permanently mounted to the body, this would allow for removal if desired and replacement with different bark or with some other surface treatment. Alternatively, the body may be absent a body cover and the hollow semi-cylindrical core 130 may have a surface treatment configured to resemble natural wood bark.

The base 112 is substantially the same as the base 12 described in the previous embodiments. The base 112 has a generally triangular shape to facilitate the flow of grain through the feed slots 152. The body 114 is mounted above a raised central ridge 148 that extends along the length of the base 112 and form feed slots 150 through which gravity-fed grain flows from the interior of the body 114. The base 112 has a series of downstream feed dishes 152, separated by raised ribs 156, which capture and accumulate the grain that falls by gravity through the feed slots 150. Molded in feed stops 154 will retard most of the grain from continuing down the feed dishes 152 onto the surrounding ground. The feed dishes 152 are wide and flat and therefore minimize choking or jamming of the grain as it feeds out of the animal feed trough 100, as is the case with many other gravity feeders that attempt to transport grain from a large bin through narrow tubes. The feed dishes 152 extend laterally along the length of the trough 100, promoting even flow of grain along the length of the animal feed trough 100 and permitting several animals to feed at the same time. Placement of the feed dishes 152 on both sides of the trough 100 further promotes even flow of grain along the length of the animal feed trough 100 and permits several animals to feed at the same time on opposite sides of the animal feed trough 100. The feed dishes 152 are defined by raised ribs 156 which extend downwardly from the central ridge 148. As described with the previous embodiments, the ribs 156 include notches into which the hollow semi-cylindrical core 130 is positioned. While the angle of declination of the feed dishes 152 may vary, in one preferred embodiment the angle of declination of the feed dishes 152 is 25 degrees, but may optionally be between 15 and 35 degrees. In some embodiments the base 112 further includes a flow adjuster to modulate the flow of grain into the feed dishes 152. In some embodiments, the flow adjuster is a mesh lining covering the opening. Additionally, or alternatively, the flow adjuster is a lip affixed to the inside edge of the body 130 configured to slow the flow of grain into the feed dishes 52. The base 112 may be comprised of a thermoplastic such as ABS or polyurethane. In some embodiments, the base 112 is formed via rotocasting.

While size and capacity can substantially vary, in one preferred embodiment the animal feed trough 100 has a length of 36 in. (91.4 cm); a height of 22.25 in. (56.5 cm); a width of 36 in. (91.4 cm), with a body 12 diameter of 22 in. (55.9 cm). Grain capacity may be approximately 250 lbs. (113 kg.) depending on the type of grain, moisture content and similar factors. In another preferred embodiment, the feeder 100 has a length of 34 in. (86.4 cm); a height of 22.25 in. (56.5 cm); a width of 36 in. (91.4 cm), with a body 12 diameter of 22 in. (55.9 cm). Grain capacity may be approximately 200 lbs. (90.7 kg.) depending on the type of grain, moisture content and similar factors.

In some embodiments, the animal feed trough 100 may be configured with a motor and a timer to open/close or dispense feed at a predetermined time. In some embodiments, the timer may be battery-powered.

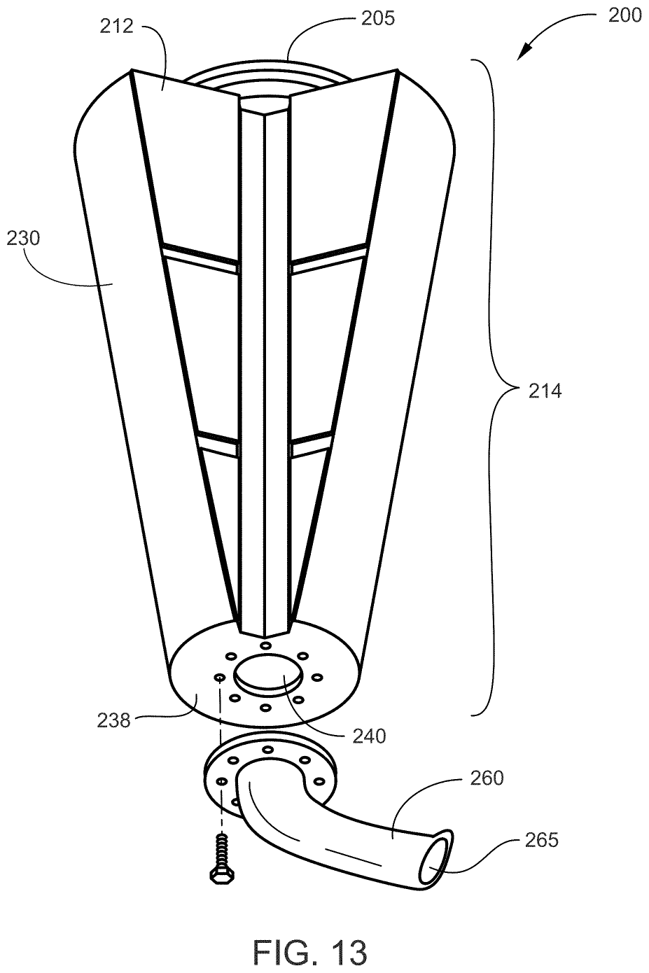

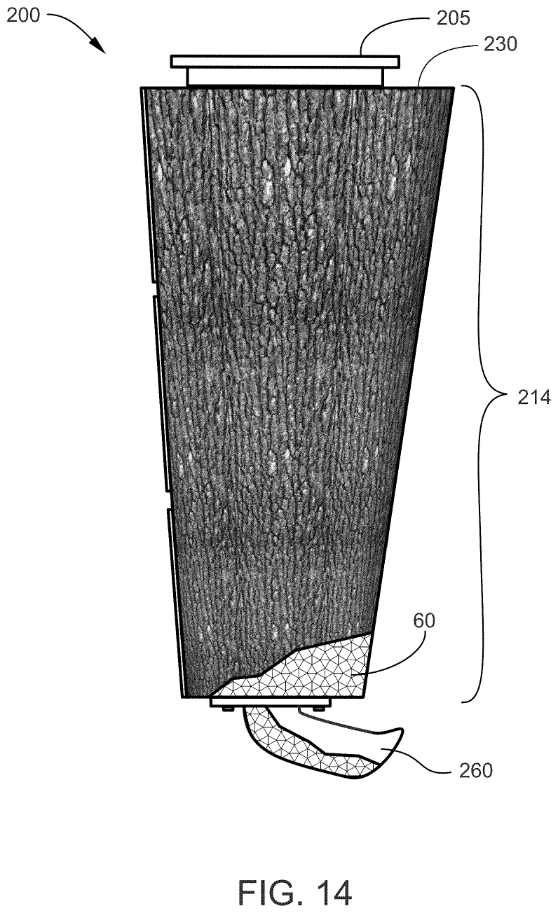

An additional embodiment is illustrated in FIGS. 13 and 14. The mounted animal feed trough device 200 includes a body defined by a tapered hollow semi-cylinder 230, a first end cap (not shown), a second end cap 238, and a tapered triangular back-side 212; forming an interior for storing grain 60. The animal feed trough device 200 is configured to be mounted to a tree or pole. In some embodiments, the mounted animal feed trough device 200 is mounted to a tree via a bracket attached to the mounted animal feed trough device 200. Additionally, or alternatively, the animal feed trough device 200 is mounted to a tree via a strap attached to the animal feed trough device 200.

The first end cap is configured with a cylindrical opening 205. The cylindrical opening 205 is configured to receive a lid. In some embodiments, the lid screws into the cylindrical opening 205. Additionally, or alternatively, the lid my snap into the cylindrical opening 205. In some embodiments, the lid is a Gamma Seal Lid®.

The second end cap 238 comprises a hole 240 for the grain to leave the body of the animal feed trough device 200. In some embodiments, the mounted animal feed trough device 200 further includes a feed tube 260. The feed tube 260 is configured to attach to the hole 240 and allow animals, such as deer to engage the snout hole 265 to gain access to the grain 60.

The external surface of the body 230 may comprise a wood bark configuration. Additionally, or alternatively, the mounted animal feed trough device 200 may further comprise a body cover that comprises dried wood bark as described previously. The external surface of the feed tube 260 is also configured with a wood bark configuration.

The tapered hollow semi-cylinder 230 may be comprised of a thermoplastic such as ABS or polyurethane. In some embodiments, the tapered hollow semi-cylinder 230 is formed via rotocasting. In some embodiments, the mold used during rotocasting comprises a natural wood bark pattern resulting in a wood bark configuration on the external surface of the body 214.

The tapered hollow semi-cylinder 230 may be comprised of a thermoplastic such as ABS or polyurethane. In some embodiments, the tapered hollow semi-cylinder 230 and the first end cap and second end cap 238 are rotocasted from the same mold. Alternatively, the tapered hollow semi-cylinder 230 is rotocasted in a separate mold from the first end cap and second end cap 238, and assembled after removal from the mold. In some embodiments, the first end cap and second end cap 238, may be bolted or riveted to the tapered hollow semi-cylinder 230.

In some embodiments, the body 214 may further include a body cover. The body cover may be natural wood bark. Preferably, the bark is subjected to a kilning process that stabilizes the bark and sets the bark in the correct curvature to match the curvature of the tapered hollow semi-cylinder 230. The body cover may also be a polymeric material configured to resemble wood bark. Suitable polymeric materials include: ABS, polyurethane, as well as other thermoplastics. In some embodiments, where the mounted animal feed trough device 200 comprises a body cover, the body cover may be attached by a weak adhesive, or mechanically attached by clips, latches, pins or other similar attachment devices. The body cover may be non-permanently mounted to the body, this would allow for removal if desired and replacement with different bark or with some other surface treatment. Alternatively, the body may be absent a body cover and the tapered hollow semi-cylinder 230 may have a surface treatment configured to resemble natural wood bark.

While size and capacity can substantially vary, in one preferred embodiment the mounted animal feed trough device 200 a height of 42 in. (106.7 cm); a diameter of the first end cap of 22 in. (91.4 cm); and a diameter of the second end cap of 18 in. (45.7 cm). Grain capacity may be approximately 150 lbs. (68 kg.) depending on the type of grain, moisture content and similar factors.

In some embodiments, the mounted animal feed trough device 200 may be configured with a motor and a timer to open/close or dispense feed at a predetermined time. In some embodiments, the timer may be battery-powered.

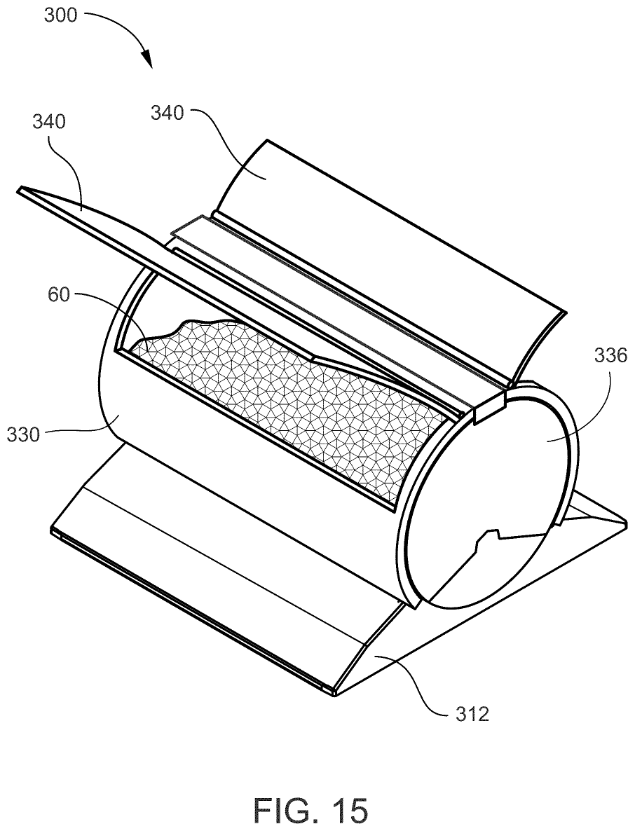

An additional embodiment is illustrated in FIG. 15. The top-feed animal feed trough 300 includes a body defined by a hollow semi-cylinder 330 flanked by two end caps 336 forming an interior for storing grain 60, and a base 312. The body has one or more hinged lids 340. The body 330 is configured to be mounted on and supported by the base 312.

The one or more hinged lids 340 are configured for opening the body of the top-feed animal feed trough 300 for adding grain into the body. Additionally, the one or more hinged lids 340 are configured to be opened to allow animals to feed from the body of the top-feed animal feed trough 340. The one or more hinged lids 340 may be opened at desired times to train animals to eat at desired times. In some embodiments, the top-feed animal feed trough 300 further comprises a motor and a timer configured to open and close the one or more hinged lids 340 at a desired time. In some embodiments, the timer and motor may be battery-powered.

The external surface of the body 330 and the external surface of the one or more hinged lids 340 may comprise a wood bark configuration. Additionally, or alternatively, the top-feed animal feed trough 300 may further comprise a body cover and one or more hinged lid covers that comprise dried wood bark as described previously.

The hollow semi-cylinder 330 may be comprised of a thermoplastic such as ABS or polyurethane. In some embodiments, the hollow semi-cylinder 330 is formed via rotocasting. In some embodiments, the mold used during rotocasting comprises a natural wood bark pattern resulting in a wood bark configuration on the external surface of the body. The one or more hinged lids 340 may be comprised of a thermoplastic such as ABS or polyurethane. In some embodiments, the one or more hinged lids 340 is formed via rotocasting. In some embodiments, the mold used during rotocasting comprises a natural wood bark pattern resulting in a wood bark configuration on the external surface of the body.

In some embodiments, the two end caps 136 may be comprised of exterior grade plywood. Alternatively, the two end caps 136 may be comprised of a thermoplastic such as ABS or polyurethane. In some embodiments, the hollow semi-cylinder 330 and the two end caps 336 are rotocasted from the same mold. Alternatively, the hollow semi-cylinder 330 is rotocasted in a separate mold from the two end caps 336, and assembled after removal from the mold. In some embodiments, the two end caps 336, may be bolted or riveted to the hollow semi-cylindrical core 130. The two end caps 136 are configured to mount the base 312. The base 312 is also comprised of a thermoplastic, such as ABS or polyurethane. In some embodiments, the base 312 is formed via rotocasting.

In some embodiments, the hollow semi-cylinder 330 may further include a body cover. Additionally, or alternatively, the one or more hinged lids 340 may further include one or more hinged lid covers. The body cover and the one or more hinged lid covers may be natural wood bark. Preferably, the bark is subjected to a kilning process that stabilizes the bark and sets the bark in the correct curvature to match the curvature of the hollow semi-cylinder 330 and the one or more hinged lids 340. The body cover and the one or more hinged lid covers may also be a polymeric material configured to resemble wood bark. Suitable polymeric materials include: ABS, polyurethane, as well as other thermoplastics. In some embodiments, where the feeder 300 comprises a body cover and the one or more hinged lid covers, the body cover and the one or more hinged lid covers may be attached by a weak adhesive, or mechanically attached by clips, latches, pins or other similar attachment devices. The body cover and the one or more hinged lid covers may be non-permanently mounted to the body, this would allow for removal if desired and replacement with different bark or with some other surface treatment. Alternatively, the body may be absent a body cover and the hollow semi-cylinder 330 may have a surface treatment configured to resemble natural wood bark.

While size and capacity can substantially vary, in one preferred embodiment the top-feed animal feed trough 300 has a length of 36 in. (91.4 cm); a height of 22.25 in. (56.5 cm); a width of 36 in. (91.4 cm), with a body 12 diameter of 22 in. (55.9 cm). Grain capacity may be approximately 250 lbs. (113 kg.) depending on the type of grain, moisture content and similar factors. In another preferred embodiment, the feeder 10 has a length of 34 in. (86.4 cm); a height of 22.25 in. (56.5 cm); a width of 36 in. (91.4 cm), with a body 12 diameter of 22 in. (55.9 cm). Grain capacity may be approximately 200 lbs. (90.7 kg.) depending on the type of grain, moisture content and similar factors.

An animal feed trough according to the invention has been described with reference to specific embodiments and examples. Various details of the invention maybe changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. An animal feed trough, comprising:
a base having a triangular configuration defined by a central ridge extending along a length of the base, tapering downwardly and outwardly from the central ridge to define a plurality of feed dishes extending along the length of the base;
a body defined by a hollow semi-cylinder and opposing spaced-apart end caps defining an interior for storing a supply of grain, the body configured to be mounted on and supported by the base and having an open bottom including feed slots for gravity flow of grain from the body onto the base and into the plurality of feed dishes;
a cylindrical opening in a top most portion of the body for introducing grain into the interior of the body; and
a round lid configured to close the cylindrical opening.

2. The animal feed trough according to claim 1, wherein the round lid is configured to snap into the cylindrical opening.

3. The animal feed trough according to claim 1, wherein an external surface of the body comprises a wood bark configuration.

4. The animal feed trough according to claim 1, further comprising a body cover attached to an outer surface of the hollow semi-cylinder of the body.

5. The animal feed trough according to claim 4, wherein the body cover comprises dried wood bark.

6. The animal feed trough according to claim 1, wherein the body and the base comprise a polymeric material.

7. The animal feed trough according to claim 6, wherein the body and the base comprise polyurethane.

8. A mounted animal feed trough comprising:
a body defined by a tapered hollow semi-cylinder, a first end cap having a first diameter,
a second end cap having a second diameter, and a tapered triangular back-side,
forming an interior for storing a supply of grain,
wherein the second diameter is less than the first diameter,
wherein the first end cap comprises a cylindrical opening for introducing grain into the interior of the body, and
wherein the second end cap comprises a hole for releasing grain from the interior of the body; and
a round lid configured to close the cylindrical opening.

9. The mounted animal feed trough according to claim 8, wherein the round lid is configured to snap into the cylindrical opening.

10. The mounted animal feed trough according to claim 8, further comprising a feed port coupled to the hole of the second end cap.

11. The mounted animal feed trough according to claim 8, wherein an external surface of the body comprises a wood bark configuration.

12. The mounted animal feed trough according to claim 8, further comprising a body cover attached to the outer surface of the tapered hollow semi-cylinder of the body.

13. The mounted animal feed trough according to claim 12, wherein the body cover comprises dried wood bark.

14. The mounted animal feed trough according to claim 8, wherein the body comprises a polymeric material

15. The mounted animal feed trough according to claim 13, wherein the body comprises polyurethane.

16. A top-feed animal feed trough comprising:
a base;
a body defined by a hollow semi-cylinder and opposing spaced-apart end caps defining an interior for storing a supply of grain, the body configured to be mounted on and supported by the base; and
one or more hinged lids fixed to a top of the body.

17. The top-feed animal feed trough according to claim 16, wherein an external surface of the body and the one or more hinged lids comprise a wood bark configuration.

18. The top-feed animal feed trough according to claim 16, further comprising a body cover and one or more hinged lid covers, wherein the body cover and the one or more hinged lid covers comprise dried wood bark.

19. The top-feed animal feed trough according to claim 16, wherein the base, the body, and the one or more hinged lids comprise a polymeric material.

20. The top-feed animal feed trough according to claim 19, wherein the base, the body, and the one or more hinged lids comprise polyurethane.
